(19) United States
(12) Patent Application Publication
(10) Pub. No.: US 2015/0246514 A1
(43) Pub. Date: Sep. 3, 2015

(54) Apparatus for the alignment and application of a protective film to a device, and related methods

(71) Applicant: IDEM, LLC, La Jolla, CA (US)

(72) Inventors: Charlie LaColla, Riverside, CA (US); Joshua Woodcook, Riverside, CA (US)

(73) Assignee: IDEM, LLC, La Jolla, CA (US)

(21) Appl. No.: 14/290,012

(22) Filed: May 29, 2014

Related U.S. Application Data
(60) Provisional application No. 61/946,495, filed on Feb. 28, 2014.

(51) Int. Cl. B32B 37/00; B32B 37/10

(52) U.S. Cl. CPC B32B 37/0053; B32B 37/1027

(57) ABSTRACT

Generally disclosed is an apparatus for applying protective films to mobile devices or similar products without misalignment, bubbles or other defects that typically occur during protective film installations. In one embodiment, the apparatus comprises:
a base defining a guide-lane;
a support tower spanning the guide-lane, said support tower featuring (a) stationary rotating press and (b) a screen protector guide;
a device holder that is configured to receive an electronic device and be movably positioned inside the guide-lane; and,
wherein (i) placing a device in the device holder, (ii) placing a screen protector in the screen protector guide and (iii) moving the device holder through the guide-lane applies the screen protector to a screen of the device.

The more specific features of a preferred embodiment of the disclosed apparatus are described with reference to the figures.

### CROSS-REFERENCE TO RELATED APPLICATIONS

This application claims the benefit and priority of U.S. Prov. Pat. App. Ser. No. 61/946,495 (filed Feb. 28, 2014) entitled “Protective film self-aligning and application system.” This document is incorporated by reference in its entirety.

### STATEMENT REGARDING FEDERALLY SPONSORED RESEARCH OR DEVELOPMENT

Not applicable.

### BACKGROUND OF THE INVENTION

1. Field of Invention

The subject matter of this disclosure is related to the field of apparatus for the alignment and application of a protective film on a display screen of a device. More particularly, the subject matter of this written description is in the field of apparatus for aligning and applying a protective film on the touch-display screen of a smart phone or tablet computer.

2. Background of the Invention

Mobile devices, like smart phones and tablet computers, typically feature a touch display screen for operating the device. These screens are subject to damage or fouling during ordinary use. As a result, many mobile device users adhere protective films to the screens of their device.

Usually, protective films are customized to the size and shape of the device screen to be protected. Such films are pre-cut, outfitted with an adhesive, and placed adhesive side down on a non-stick backing like a sticker. In application, the custom fit sticker is peeled from the backing and positioned adhesive side down on the screen. Thus, the task of installing he protective film is primarily two-fold; (1) simultaneously aligning the film over the screen surface area; and (2) applying the film to the screen surface without blemishes (e.g., air bubbles, grime or debris, and creases). Proper alignment of the film is important. A mis-aligned screen protector drastically reduces the expected life of the protective film because mis-alignment can frequently allow for debris to more easily work its way between the protective film and screen so that the film simply peels away. Professional protective film installation exists, but is expensive and time consuming. Furthermore, a large variety in the size, shape, and components of electronic devices necessitates alignment on a case by case basis. Thus, a need exists for apparatus and related methods of quickly, properly, and universally aligning protective films with the screens and components of a variety of electronic devices.

Blemishes under the applied film are also problematic because the blemishes are unsightly and can also cause the protective film to detach from the screen. One cause of blemishes during the application of a protective film is the exposure to debris of the adhesive of the protective film. This can be particularly problematic for sticker-type protective films because the sticker-type protective film is handled for alignment over the screen after the release liner or backing for the adhesive has been removed. Applying sticker type protective liners in this manner exposes the adhesive to the environment and greatly increases the risk of debris attaching to the adhesive side of the film with poor installation being the result. Blemishes can also be caused by the misapplication of pressure when associating the protective film with the screen. Too little pressure can cause air bubbles under the film, while too much pressure can cause air bubbles and imprints (dents) in the film. It comes as no surprise that a need exists for apparatus and related methods of quickly, properly, and universally applying protective films with the screens and components of a variety of electronic devices

### SUMMARY OF THE INVENTION

In view of the foregoing, it is an object of this disclosure to describe apparatus for applying protective films to mobile devices or similar products without misalignment, bubbles or other defects that typically occur during protective film installations. In one embodiment, the apparatus comprises:
a base defining a guide-lane;
a support tower spanning the guide-lane, said support tower featuring (a) stationary rotating press and (b) a screen protector guide;
a device holder that is configured to receive an electronic device and be movably positioned inside the guide-lane; and,
wherein (i) placing a device in the device holder, (ii) placing a screen protector in the screen protector guide and (iii) moving the is device holder through the guide-lane applies the screen protector to a screen of the device.

Other objectives and desires may become apparent to one of skill in the art after reading the below disclosure and viewing the associated figures. Also, these and other embodiments will become apparent from the drawings.

### BRIEF DESCRIPTION OF THE FIGURES

The manner in which these objectives and other desirable characteristics can be obtained is explained in the following description and attached figures in which:

FIG. 1 is an exploded perspective view of an apparatus for applying protective films to mobile devices or similar products without misalignment, bubbles or other defects;

FIG. 2 is a perspective view of the apparatus;

FIG. 3 is a front view of the apparatus;

FIG. 4 is a back view of the apparatus;

FIG. 5 is a right side view of the apparatus;

FIG. 6 is a left side view of the apparatus;

FIG. 7 is a top view of the apparatus;

FIG. 8 is a bottom view of the apparatus;

FIG. 9 is a perspective view of the apparatus with a loaded electronic device and protective film;

FIG. 10 is a perspective view of the device where the protective fi is positioned for application to the electronic device;

FIG. 11. Is a perspective view of the electronic device moving through the apparatus for having the protective film applied thereto;

FIG. 12 is a perspective view of the device with the electronic device almost completely moved through the apparatus; and

FIG. 13 is a view of the apparatus where an adhesive strip is being peeled from the installed protective film.

It is to be noted, however, that the appended figures illustrate only typical embodiments of the disclosed assemblies, and therefore, are not to be considered limiting of their scope, for the disclosed assemblies may admit to other equally effective embodiments that will be appreciated by those reasonably skilled in t he relevant arts. Also, figures are not necessarily made to scale.

### DETAILED DESCRIPTION OF PREFFERED EMBODIMENTS

Generally disclosed is an apparatus for applying protective films to mobile devices or similar products without misalignment, bubbles or other defects that typically occur during protective film installations. In one embodiment, the apparatus comprises:
a base defining a guide-lane;
a support tower spanning the guide-lane, said support tower featuring (a) stationary rotating press and (b) a screen protector guide;
a device holder that is configured to receive an electronic device and be movably positioned inside the guide-lane; and,
wherein (i) placing a device in the device holder, (ii) placing a screen protector in the screen protector guide and (iii) moving the device holder through the guide-lane applies the screen protector to a screen of the device.
   The more specific features of a preferred embodiment of the disclosed apparatus are described with reference to the figures.

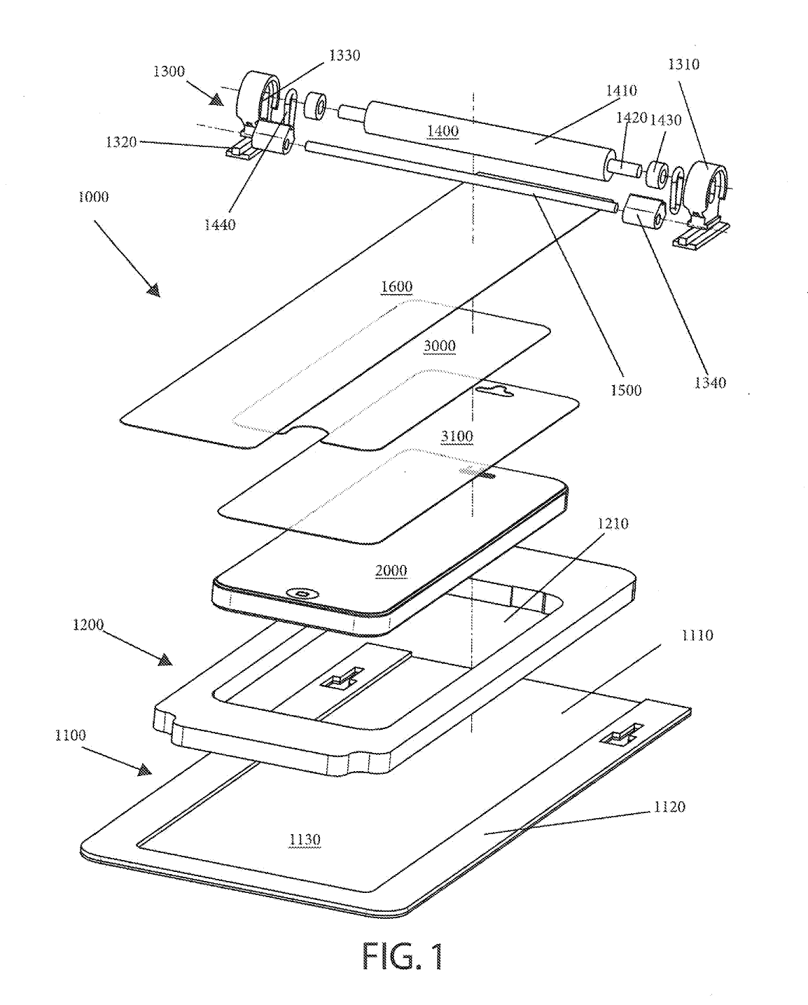

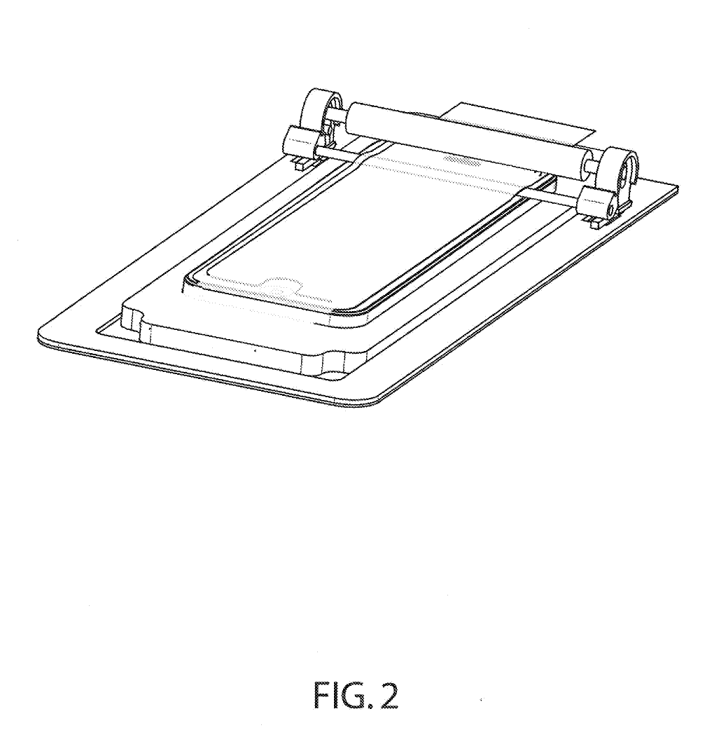

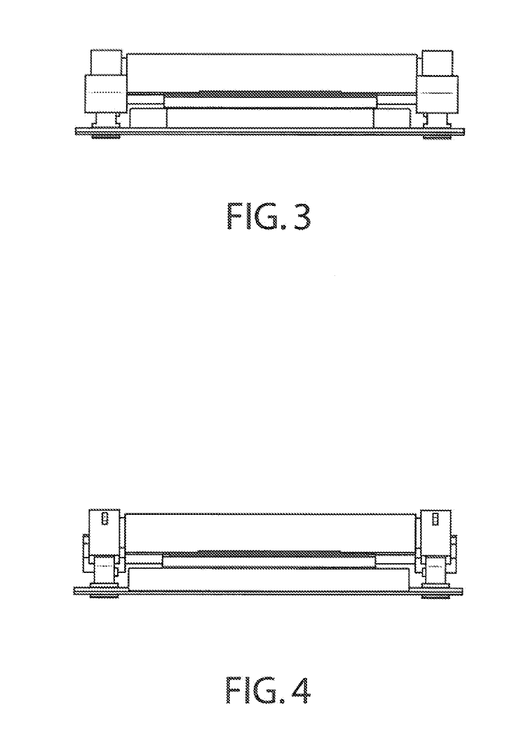

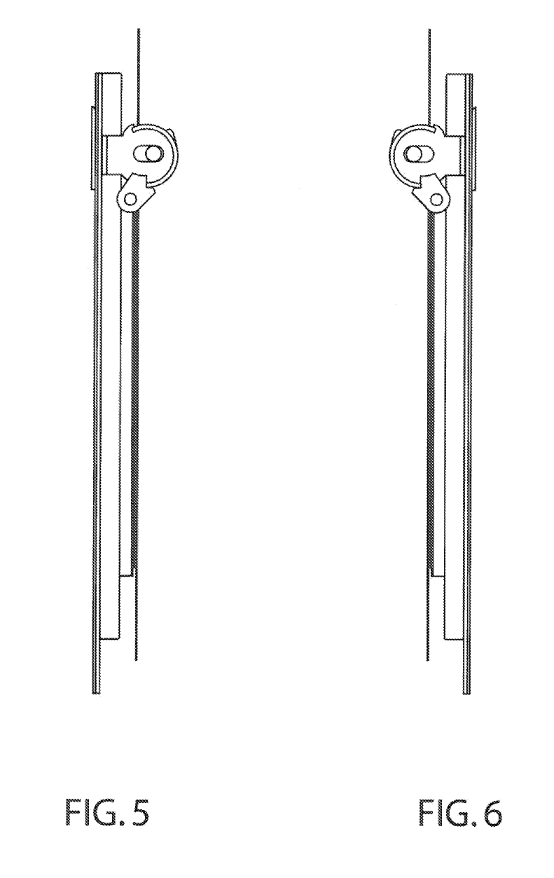

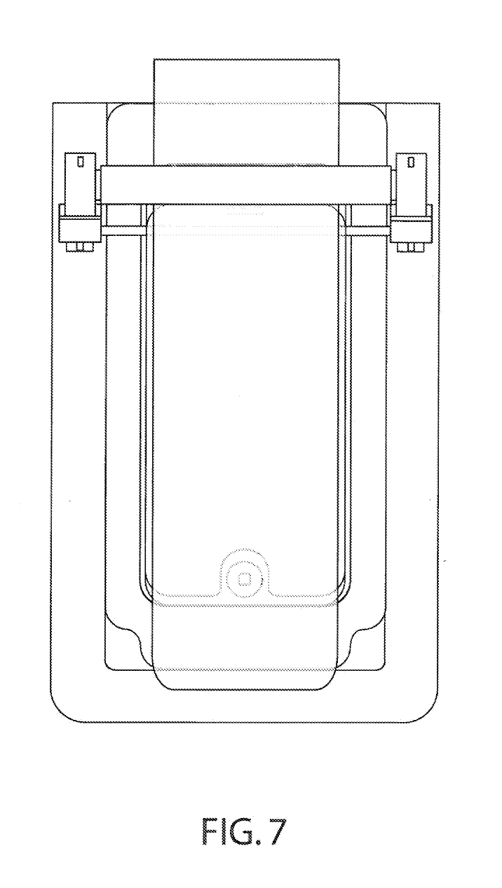

FIG. 1 is an exploded perspective view of an apparatus 1000 for providing a protective film 3000 (with backing 3100) to an electronic device 2000. FIGS. 2 through 8 are respectively perspective, front, back, right side, left side, top, and bottom views of the apparatus 1000 with the protective film 3000 and electronic device 2000 set in an initial position. These figures illustrate the components of the disclosed apparatus 1000. As shown the apparatus 1000 is comprised of six main subassemblies: (1) a base 1100 with a guide-lane 1130; (2) a device holder 1200 that is configured for movable positioning within the guide-lane 1130 of the base 1100; (3) cooperating towers 1300 (collectively “towers 1300”) upstandingly coupled to the base 1100 on either side of the guide-lane 1130; (4) a press 1400 that is rotatably coupled to both towers 1300 so that it spans the guide-lane 1130; (5) a set bar 1500 that is coupled to both towers 1300 so that (a) it spans the guide-lane 1130 and (b) it is movable between a front and back position relative to the towers 1130; and (6) a gradient tape 1600 that is configure to couple the protective film 3000 to the press 1400.

Referring to FIGS. 1 through 8, the base 1100 is suitably defined by a base plate 1110 that supports a “U” shaped sidewall 1120 upstanding from the surface of the base plate 1110. Suitably, the sidewalls 1120 define the guide-lane 1130 for the device holder 1200. The device holder 1200 is defined by a receptacle 1210 for receiving electronic devices 2000 (shown in FIGS. 1 through 8 as an iPhone®). As shown in the figures, the towers 1300 define a spindle 1330 for the press 1400, which spans the guide lane 1230 and is configured to rotate whenever the device holder 1200 is moved along the guide lane 1130 of the base 1100. The set bar 1500 spans the guide lane 1130 so that it is coupled to both towers 1300 on a track 1310 which allows the set bar 1500 to move circumferencaly around the towers 1300 from a position in front of the towers 1300 to a position behind the is towers 1300. Finally, the gradient tape 1600 is configured to be adhered to the protective surface of a protective film. In preferred embodiment, the gradient tape 1600 spans a protective film and features a variable adhesive gradient (stronger on one side of the protective film than the other side) for securing the tape 1600 to the protective film. As discussed in greater detail below, the device holder 1200 and base 1100 cooperate to movably position the device 2000 in alignment with the tower 1300 so that a protective film 3000 may be aligned by the set bar 1500, positioned on the press 1400 via a gradient tape 1600 and forcefully applied to the screen of the device 2000 by the press 1400 as the device holder moves through the guide lane 1300.

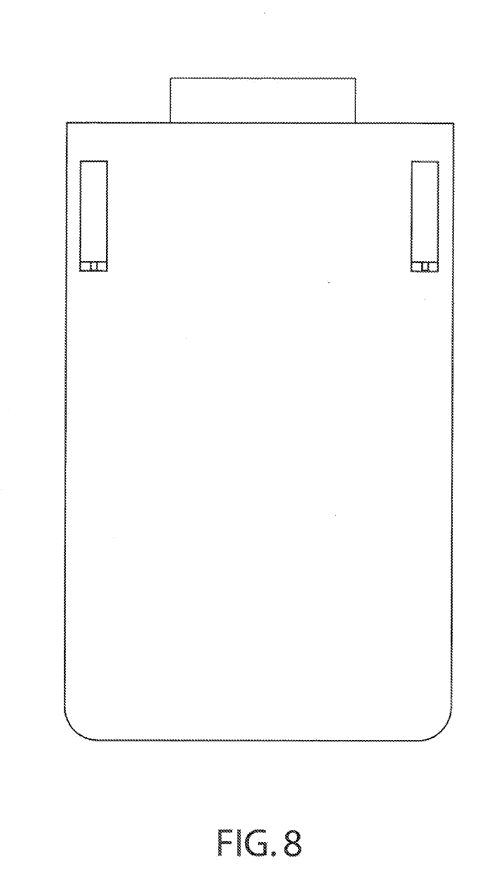

FIG. 1 is an exploded view of the apparatus 1000 and its sub-assemblies. Suitably, FIG. 8 illustrates the components of the apparatus. As shown, those components are as follows.

The Towers 1300

The towers 1300 are suitably defined by a foot 1320, a spindle 1330, and a track 1310 for glides 1340. Suitably, the towers are coupled to the base 1100 on either side of the guide lane 1130 via the foot 1320. When coupled to the base 1100, the spindle 1330 is upstanding and the track 1310 is positioned around the spindle 1330. Suitably, the glides 1340 are seated in the track 1310. When installed the glides 1340 are configured to the width of the protective film 3000 to be installed, so that the protective film is held in place relative to the press 1400 during application to a device.

The Press 1400

In a preferred embodiment, the press 1400 is made up of a silicone tube 1410, a metal rod 1420, spacers 1430, and o-rings or bands 1440. Preferably, the silicone tube 1410 features an approximate Shore A hardness or durometer of sixty and the metal rod 1420 is constructed of hardened steel. In one embodiment, the metal rod 1420 defines the axis of the silicone tube 1410 and is configured for coupling to the spindle 1330 of the towers 1300 so that the press 1400 rotates relative to the towers 1300. The spacers 1430 are plastic rings positioned on either side of the silicone tube 1410 on the metal rod 1420. Suitably, the spacers 1420 define the position of the tube 1410 along the metal rod 1420 and operate to separate the silicone tube 1410 from the towers 1300, when installed, so that the tacky silicon material does not bind against the spindle 1330 during rotation of the press 1400. Finally, the o-rings or bands 1440 are coupled to the metal rod 1420 and foot 1320 of the towers 1300 to apply a uniform force along the metal rod 1320 when the press 1400 is installed on the spindle 1330 of the towers 1300. Suitably, as discussed further below, the o-rings or bands 1440 provide a predetermined or prescribed downward force required to apply a screen protector 3000 perfectly and without haze or bubbles. Also discussed in greater detail below, silicone is a soft material and is meant to compress 1440 against the screen protector and display screen to ensure a bubble free application and the metal rod transfers the downward forces of the bands 1440 evenly across the width of the apparatus 1000 to ensure an even bubble free application.

Material Set Bar 1500

The material set bar 1500 is a metal rod coupled to the glides 1340 of the towers 1300. Suitably, the set bar 1500 and glides 1340 and are meant to hold the screen protection film 3000 in an optimal position during installation. Suitably, the glide 1340 ride along the top curvature or track 1310 of the towers.

The Base 1100

The base 1100 is suitably defined by a base plate 1110 that supports a “U” shaped sidewall 1120 upstanding from the surface of the base plate 1110. The base plate 1110 defines the footprint of the apparatus 1000 and supports all other components. Suitably, the sidewalls 1120 define the guide-lane 1130 for the device holder 1200. In one embodiment, the purpose of the guide-lane 1130 is to guide the device holder 1200 as it slidably moves through the press 1400. Suitably, the base is designed to receive the device holder 1200 universally so that multiple device holders configured with receptacles for a variety of mobile devices may be used for applying screen protectors to multiple devices via the same apparatus 1000.

Device Holder 1200

The device holder 1200 is defined by a receptacle 1210 for receiving electronic devices (shown in FIGS. 1 through 8 as an iPhone® 2000). This component is, in a preferred embodiment, constructed of a foam core with a card stock laminate. As alluded to above, the device holder 1200 provides for proper alignment of the mobile device 2000 and the press 1400. Suitably, the device holder 1200 is configured to slide on top of base plate 1110 within the guide-lane 1130.

A universal device holder 1200 is desirable so that the device holder 1200 may accept a variety of differently sized electronic devices. Such holders 1200 could be stamped, injection molded or made of a variety of substrates, metals, foams and or plastics

Gradient Tape 1600

The gradient tape 1600 is preferable for the installation of the screen is protector on an electronic device 2000. In preferred embodiment, the gradient tape 1600 spans a protective film and features a variable adhesive gradient (stronger on one side of the protective film than the other side) for securing the tape 1600 to the protective film. Suitably, the adhesive gradient is strongest near the top of the screen protector and weakest at the bottom. At the top side of the tape 1600, a strong adhesive hold is required to prevent the screen protector from pre-releasing and mis-installing as the screen protector bends around the press 1400 (discussed in further detail below) for application to the screen of the electronic device 2000. At the bottom side of the tape 1600, the adhesive is relatively weak so that a user can gradually peel the gradient tape (from weak to strong adhesive) off of an installed screen protector without simultaneously pulling the screen protector free from the screen after installation.

Suitably, graduated adhesive may be applied to the tape 1600 surface that makes contact with the screen protector. The tape 1600 with graduated adhesive would need to be laminated, by machine or hand, to the screen protector material. Suitably, the screen protection film can be customized to match the desired device before or after lamination depending on the manufacturer's preference.

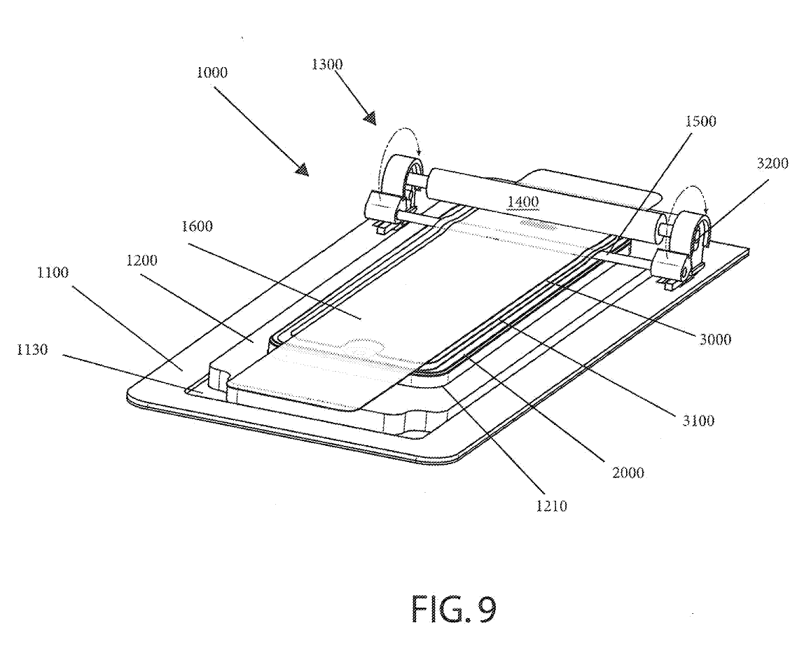

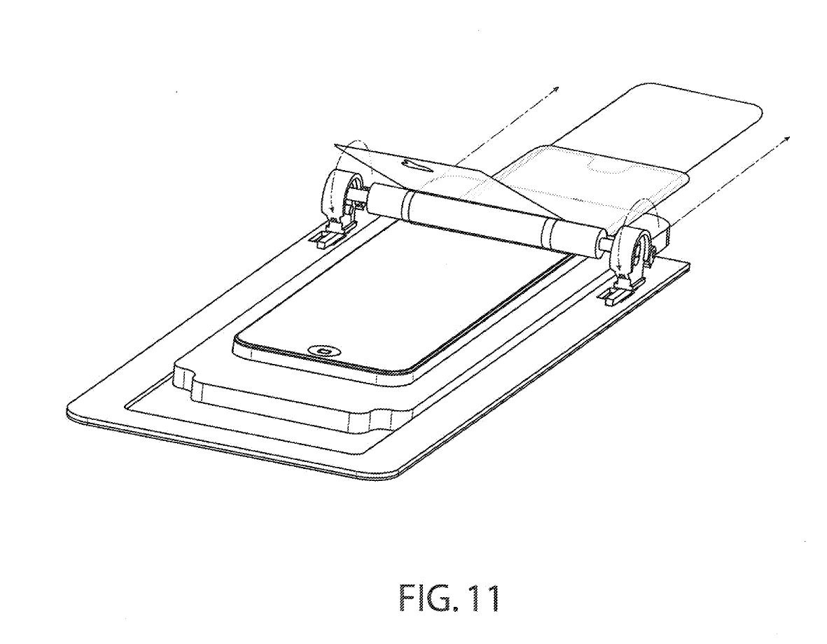

FIGS. 9 through 13 illustrate a mode of operation for the apparatus 1000 to install a protective film 3000 on an electronic device 2000. Referring first to FIG. 9, an electronic device 2000 is positioned within the receptacle 1210 of the device holder 1200. Suitably, the device holder 1200 and phone 2000 are positioned within the guide lane 1130 so that the top of the device 2000 is positioned just in front of the press 1400. Suitably, the tape 1600 may be adhered to the non-adhesive side of the protective film 3000 so that the stronger adhesive of the tape 600 adhered to the protective film at the part that will cover the top of the device 2000. Next, the tape 1600 and protective covering 3000, including the backing 3100, are loaded into the press 1400 so that the top end of the tape 1600 is positioned under the press while the backing 3100 is positioned over the set bar 1500.

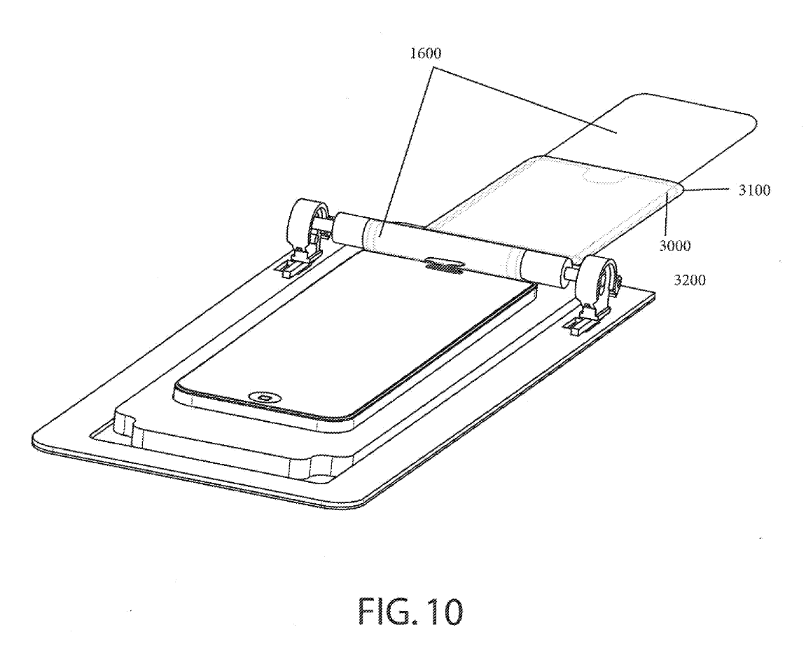

FIGS. 9 and 10 show the apparatus 1000 transitioning to a configuration for application of the film 3000 to the device 2000. Once the device holder 1200 and tape 1600/protective covering 3000 assembly have been loaded (FIG. 9), the set bar 1500 is moved around the spindle 1320 (as the arrows drawn in FIG. 9) of the towers 1300 so that the tape 1600 and protective film 300 wrap over the silicon tube 1410 (FIG. 10), adhesive side out, while the backing 3100 is partially peeled off the protective film 3100. This configuration is shown in FIG. 10.

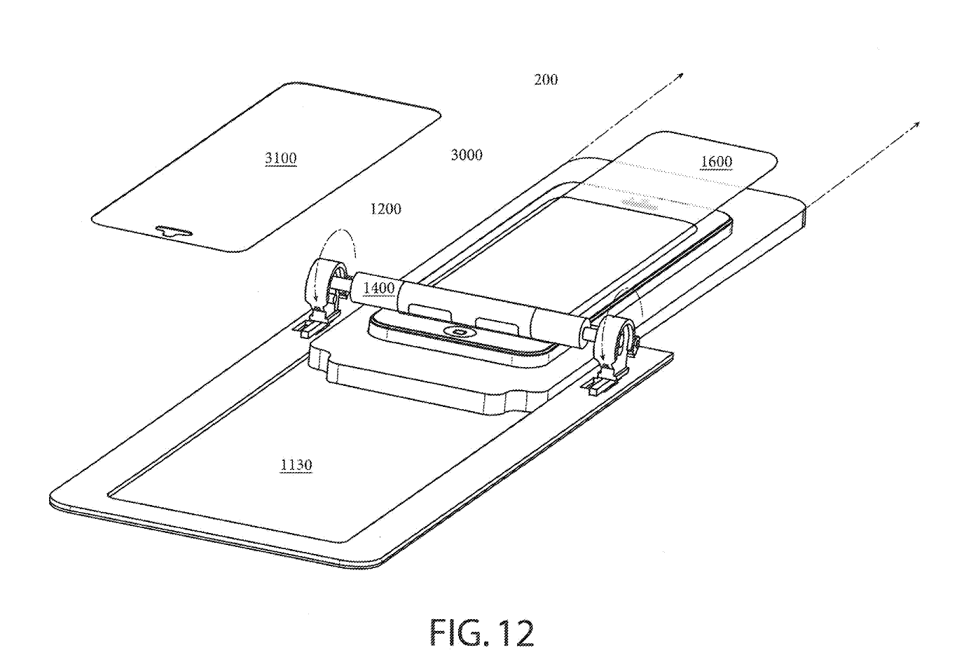

Lastly, as shown in FIG. 12, the device holder 1200 and device 2000 are moved through the guide lane 1130 underneath the press 1400. Suitably, the bands 1440 (not shown) apply a downward force so that the press 1400 evenly contacts the device 2000. Suitably, the action of the moving device holder 1200 causes the press 1200 to rotate. As the press 1400 rotates, the protective film 3000 is applied, adhesive side down, to the screen of the device 2000 and bubbles are avoided due to the uniform application of the force of the bands 1440. The backing 3100 suitably peels off of the protector film 3000 as the film 3000 is rollably applied to the device 2000.

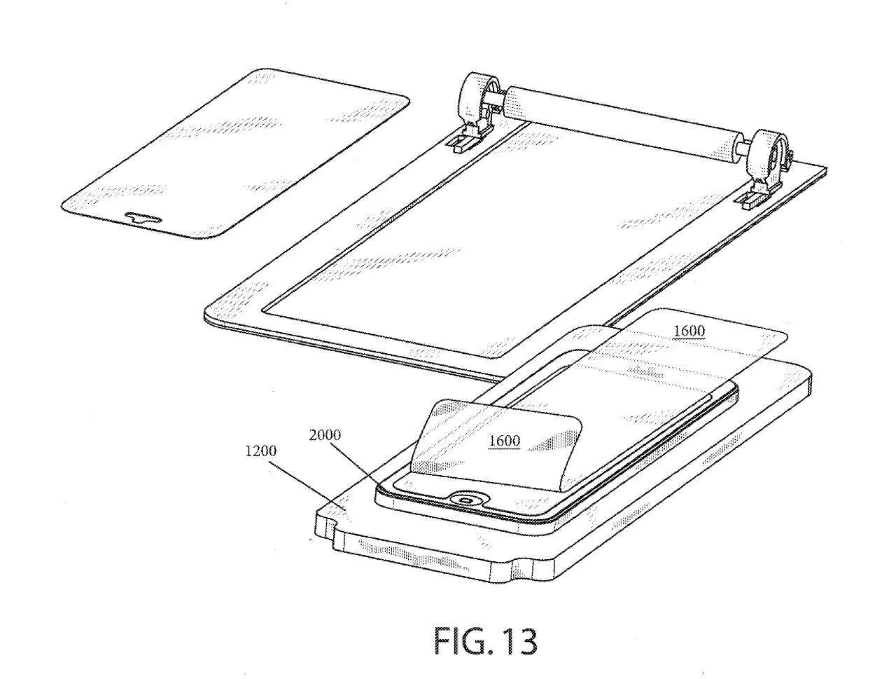

Referring to FIG. 13, once the screen protector 3000 has been applied to the device 2000, the device 2000 may be removed from the device holder 1200 and the tape 1600 removed from the screen protector 3000. Suitably, the tape 1600 is removed via gradually peeling the tape 1600 from the weaker adhesive side first.

While various embodiments of the method and apparatus have been described above, it should be understood that they have been presented by way of example only, and not of limitation. Likewise, the various diagrams might depict an example of an architectural or other configuration for the disclosed method and apparatus, which is done to aid in understanding the features and functionality that might be included in the method and apparatus. The disclosed method and apparatus is not restricted to the illustrated example architectures or configurations, but the desired features might be implemented using a variety of alternative architectures and configurations. Indeed, it will be apparent to one of skill in the art how alternative functional, logical or physical partitioning and configurations might be implemented to implement the desired features of the disclosed method and apparatus. Also, a multitude of different constituent module names other than those depicted herein might be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the method and apparatus is described above in terms of various exemplary embodiments and implementations, it should understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term ‘including” should be read as meaning “including, without limitation” or the like, the term “example” is used to provide exemplary instances of the item in discussion, not an exhaustive or limiting list thereof, the terms “a” or “an” should be read as meaning “at least one,” “one or more” the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that t he narrower case is intended or required in instances where such broadening phrases might be absent. The use of the term “module” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become a parent to one of ordinary skill in the art after reading this document, the illustrated embodiments and their various alternatives might be implemented without confinement to the illustrated examples. For example, block diagrams and their accompanying description should not be construed as mandating a particular architecture or configuration.

I claim:

1. An apparatus for applying a protective film comprising:
a base with a guide lane;
a rotating press that spans the guide lane, said press configured to apply force toward the guide lane;
a set bar that spans the guide lane and that is movable around the rotating press;
a device holder configured to receive a device and movably fit within the guide lane;
wherein loading the press with a protective film that features gradient tape and moving a device through the press via the guide lane applies the protective film to the device.

2. A method of applying a protective film comprising the step of:
is locating an apparatus comprising a base with a guide lane, a rotating press that spans the guide lane, and a set bar that spans the guide lane and that is movable around the rotating press;
locating a device holder that is configured to retain a device and movably fit in the guide lane;
loading a device into the device holder;
placing the device holder in the guide lane;
obtaining a protective film for the device;
placing a gradient tape on the protective film;
loading the protective film and gradient tape into the apparatus so that the tape and film are underneath the press and over the set bar;
moving the set bar around the rotating press; and,
moving the device holder through the guide lane;
